(19) United States
(12) Patent Application Publication
(10) Pub. No.: US 2024/0029918 A1
(43) Pub. Date: Jan. 25, 2024

(54) ARMOURED SUBMARINE POWER CABLE

(71) Applicant: NKT HV Cables AB, Lyckeby (SE)

(72) Inventor: Thomas Worzyk, Lyckeby (SE)

(21) Appl. No.: 18/248,889

(22) PCT Filed: Oct. 8, 2021
(86) PCT No.: PCT/EP2021/077908

§ 371 Date: Apr. 13, 2023

(30) Foreign Application Priority Data
Oct. 13, 2020 (EP) 20201607.7

(51) Int. Cl. H01B 7/14; H01B 7/22

(52) U.S. Cl. CPC H01B 7/14; H01B 7/226

(57) ABSTRACT

A submarine power cable including: a first conductor, a first insulation system provided around the first conductor, and a plurality of elongated armour elements forming an armour layer surrounding the first insulation system, wherein each elongated armour element is made of a plurality of individual wires that are stranded, wherein at least some of the individual wires include metal.

TECHNICAL FIELD

The present disclosure generally relates to armoured submarine power cables.

### BACKGROUND

Submarine power cables may often have an armour comprising a plurality of armour wires. The armour wires normally extend helically around the single core or multi-core of the submarine power cable. The armour provides mechanical protection against lateral impacts during installation and operation of the cable. The armour also provides tensional force for the cable laying.

There are some disadvantages with steel armouring. In AC power cables, the alternating magnetic field induces different kind of losses in the armour. There are eddy current losses where an induced current is flowing inside the individual wire in a circle in a plane parallel to the cable axis. The amplitude of these losses is depending on the third power of the armour wire diameter. Another loss category is caused by the induced longitudinal current in the armour wires. Both loss categories increase the temperature of the power cable and reduce the useful power rating. Further, steel armour wires have a limited tensional strength, which can be a limiting factor when designing cables for vary large installation depths. Additionally, the cable must be covered by armour wires without large gaps between the armour wires. If the cable is very large in diameter and the armouring machine is limited in the number of wires that can be processed at the same time, the individual wires must be very large in diameter to provide a fully covering armour. The handling of such large wires in the factory can be complicated and even risky and leads to higher armour losses as explained above.

Some of these disadvantages can be overcome. The eddy current losses can be largely reduced by using non-magnetic metal materials like stainless steel or copper. However, these substitute materials are much more expensive than mild steel. Further, the tensional strength of the armour can be improved by using high-grade steel, which is more expensive than mild steel. It has also been proposed to use non-metallic armour wires such as wires made of aramid or para-aramid. This can increase the tensile force of the armour, reduce the weight, and eliminate the losses completely. However, the cost of non-metallic armour is expected to be much higher than for a metal armour.

### SUMMARY

In view of the above, a general object of the present disclosure is to provide an armoured submarine power cable that solves or at least mitigates the problems of the prior art.

There is hence provided a submarine power cable comprising: a first conductor, a first insulation system provided around the first conductor, and a plurality of elongated armour elements forming an armour layer surrounding the first insulation system, wherein each elongated armour element is made of a plurality of individual wires that are stranded, wherein at least some of the individual wires comprise metal.

The tensional strength of the armour layer is thereby increased without the need of more expensive materials for the elongated armour elements. This enables installation of the submarine power cable in deeper waters. Further, the armour layer will have substantially lower losses due to substantially lower eddy current losses. Thus, for example, the cross-section of the first conductor may be made smaller. The cross-section of the entire submarine power cable may thus be made smaller. Alternatively, the rating of the submarine power cable may be increased. Moreover, the handling of the individual wires in the factory is much easier and less risky than the handling of solid armour wires of the same cross-section.

Assume eddy current losses in a traditional armour wire is PE for a given cable current and cable geometry. If this armour wire is replaced by a group of individual wires as disclosed herein, with, as an example, the individual wires having a diameter of ⅓ of the traditional armour wire and the number of individual wires replacing the single traditional wire being seven, the combined eddy current losses in the group of individual wires would be P_{E}′, =(⅓)³*7*P_{E}=0.26*P_{E}. The eddy current losses would thus in this case be reduced by 74%.

The submarine power cable may be an AC submarine power cable or a DC submarine power cable.

The submarine power cable may be a medium voltage or high voltage submarine power cable.

The submarine power cable is according to one embodiment not an umbilical.

The submarine power cable may be a static submarine power cable or a dynamic submarine power cable.

The armour elements may be galvanized. Each individual wire may for example be galvanized.

According to one example all the individual wires comprise metal. All the individual wires of all the armour elements may comprise or consist of metal.

The metal may be steel.

According to one embodiment the metal is mild steel.

According to one embodiment the metal is stainless steel.

According to one embodiment each elongated armour element is a wire rope.

According to one embodiment a diameter of each elongated armour element is in the range of 4-8 mm, such as 5-6 mm.

According to one embodiment for at least one of the elongated armour elements all individual wires have the same diameter.

According to one variation, at least one of the elongated armour elements comprises individual wires that have differing diameter.

According to one embodiment at least one of the elongated armour elements comprises a central individual wire and six individual wires wound around the central individual wire.

According to one embodiment the elongated armour elements are arranged helically along an axial direction of the submarine power cable.

One embodiment comprises a first water barrier arranged between the first insulation layer and the armour layer.

According to one embodiment the first water barrier comprises a metallic sheath.

The metallic sheath may for example comprise copper, stainless steel or aluminium.

According to one embodiment the first water barrier comprises a polymer sheath.

The first water barrier may comprise a metallic sheath and a polymer sheath arranged radially outside of the metallic sheath. The polymer sheath may for example comprise a semiconductive polymer material. The polymer material may for example be polyethylene.

The first water barrier may comprise an adhesive arranged between the metallic sheath and the polymer material. The adhesive may for example be semiconductive.

According to one embodiment the first conductor and the first insulation system form part of a first power core, wherein the submarine power cable comprises: a second power core comprising: a second conductor, and a second insulation system provided around the second conductor; and a third power core comprising: a third conductor, and a third insulation system provided around the third conductor; wherein the first power core, the second power core and the third power core form a stranded multi-core, and wherein the armour layer surrounds the stranded multi-core.

The elongated armour elements may be helically wound around the stranded multi-core.

One embodiment comprises a corrosion protection layer provided on the armour elements.

According to one embodiment the corrosion protection layer comprises bitumen.

Other examples of a corrosion protection layers are for example tar or a polymer coating.

According to one embodiment each elongated armour element is covered with the bitumen around its entire circumference.

According to one example each individual wire of the elongated armour elements is covered with bitumen. Each individual wire is thus in direct contact with bitumen around its entire perimeter surface.

Generally, all terms used in the claims are to be interpreted according to their ordinary meaning in the technical field, unless explicitly defined otherwise herein. All references to “a/an/the element, apparatus, component, means, etc. are to be interpreted openly as referring to at least one instance of the element, apparatus, component, means, etc., unless explicitly stated otherwise.

### BRIEF DESCRIPTION OF THE DRAWINGS

The specific embodiments of the inventive concept will now be described, by way of example, with reference to the accompanying drawings, in which:

FIG. 1 shows a cross-section of an example of a submarine power cable;

FIG. 2 shows an example of an elongated armour element; and

FIG. 3 depicts a cross-section of another example of a submarine power cable.

### DETAILED DESCRIPTION

The inventive concept will now be described more fully hereinafter with reference to the accompanying drawings, in which exemplifying embodiments are shown. The inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description.

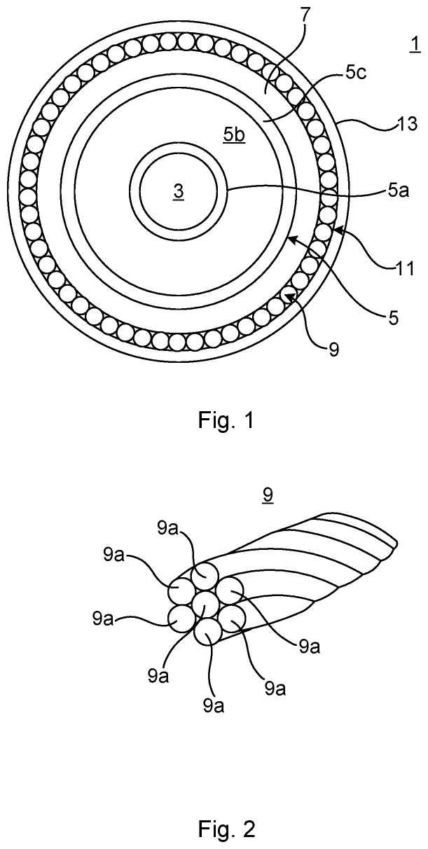

FIG. 1 shows a cross-sectional view of an example of a submarine power cable 1. The submarine power cable 1 is a single core power cable.

The submarine power cable 1 comprises a first conductor 3.

The submarine power cable 1 comprises a first insulation system 5 arranged around the first conductor 3.

The first insulation system 5 may comprise an inner semiconductive layer 5a. The inner semiconductive layer 5a is a conductor screen. The inner semiconductive layer 5a is arranged around the first conductor 3.

The first insulation system 5 may comprise an insulation layer 5b. The insulation layer 5b is arranged around the inner semiconductive layer 5a. The insulation layer 5b may for example comprise cross-linked polyethylene (XLPE), impregnated paper tapes, or polypropylene.

The first insulation system 5 may comprise an outer semiconductive layer 5c. The outer semiconductive layer 5c is an insulation screen. The outer semiconductive layer 5c is arranged around the insulation layer 5b.

The submarine power cable 1 may comprise a water barrier 7. The water barrier 7 may be arranged around the outer semiconductive layer 5c. The water barrier 7 may for example comprise a metallic sheath. The metallic sheath may for example comprise copper, stainless steel, or aluminium. The metallic sheath may for example be one or more metal sheets that is/are folded around the insulation system 5 and longitudinally welded along the length of the submarine power cable 1.

The water barrier 7 may comprise a polymer sheath. The water barrier 7 may comprise the polymer sheath instead of the metallic sheath. Alternatively, the water barrier 7 may comprise the metallic sheath and a polymer sheath arranged around the metallic sheath. The polymer sheath may comprise a semiconductive polymer material. For example, the polymer sheath may comprise carbon black. The water barrier 7 may comprise an adhesive arranged between the metallic sheath and the polymer sheath so that the polymer sheath adheres to the metallic sheath. The adhesive may be a semiconductive adhesive in case the polymer sheath comprises a semiconductive polymer material.

The submarine power cable 1 comprises a plurality of elongated armour elements 9 forming an armour layer that surrounds the insulation system 5. The armour layer also surrounds the water barrier 7, if present. The armour elements 9 comprise metal. The armour elements 9 may consist of metal. The metal may for example be steel, such as mild steel or stainless steel. Each armour element 9 is formed by a plurality of individual wires that are stranded. Each individual wire may for example be made of metal. Alternatively, some of the individual wires may be made of metal and other individual wires may be made of a non-metallic material such as a polymeric material. The armour elements 9 are laid helically along the axial direction of the submarine power cable 1. The armour elements 9 have a pitch, for example in the range of 0.5-4 metres, such as 1-3 metres. The armour elements 9 have a lay direction, which may be the left-hand direction or the right-hand direction.

The submarine power cable 1 may comprise a corrosion protection layer 11. The corrosion protection layer 11 is arranged to cover the armour layer. The corrosion protection layer 11 is arranged radially outside of the armour layer. The corrosion protection layer 11 may comprise bitumen. The bitumen may be applied onto the armour elements 9 to thereby cover the armour elements 9.

The submarine power cable 1 may comprise an outer layer 13. The outer layer 13 is arranged around the armour layer. The corrosion protection layer 11 is arranged between the outer layer 13 and the armour layer. The outer layer 13 forms the external surface of the submarine power cable 1. The outer layer 13 may for example comprise polymer yarn, such as polypropylene yarn, wound around the armour layer.

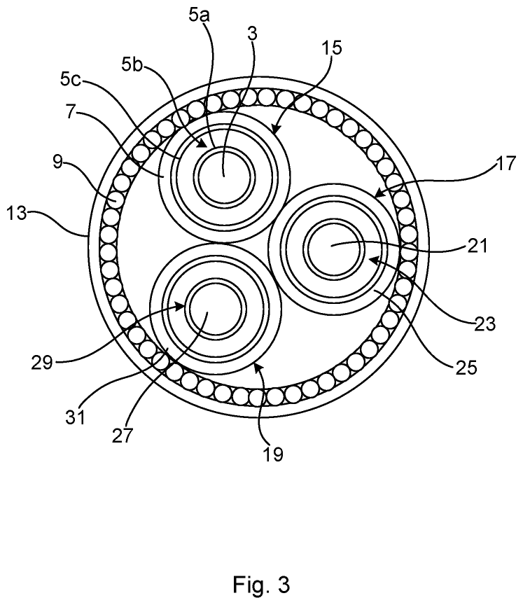

Turning now to FIG. 2 an example of one of the armour elements 9 is shown in more detail. Each armour element 9 may have this structure. The armour element 9 is made of a plurality of individual wires 9a that are stranded. The stranded individual wires 9a form the armour element 9, which is thus an armour wire made of stranded individual wires that are smaller in diameter than the cross-sectional dimension of the armour element 9.

Each individual wire 9a may comprise or consist of metal, such as steel, for example mild steel or stainless steel. According to one example, all the individual wires of the armour element 9 are made of the same metal. According to one example, the individual wires 9a of the armour element 9 may be made of different metal materials. One or more individual wires 9a may for example be made of mild steel and one or more individual wires 9a may for example be made of stainless steel.

The armour elements 9 may be wire ropes.

According to one example, each individual wire 9a is made of a plurality of stranded wires that are smaller in cross-sectional size than the individual wire 9a. That is, each individual wire 9a may itself be a stranded wire. Alternatively, each individual wire 9a may be a solid wire. According to one variation, the individual wires making up the armour element 9 may be a combination of solid individual wires and individual wires that are stranded.

According to one example, the armour element 9 may have one central individual wire, as shown in FIG. 2, and a plurality of individual wires wound around the central individual wire. The central individual wire may extend along the central axis of the armour element 9. There may for example be six or more individual wires wound around the central individual wire. Other variations are also possible. There may for example be less than six individual wires wound around the central individual wire. Further, one variation may not have any central individual wire.

All the individual wires 9a of an armour element 9 may have the same diameter. Alternatively, the diameter of at least two individual wires 9a of an armour element 9 may be mutually different. A central individual wire may for example have a diameter that differs from the individual wires wound around the central individual wire.

Each armour element 9 may be covered with bitumen around its entire circumference along its entire length. Each armour element 9 may be dipped into a bitumen bath when the submarine power cable 1 is manufactured.

FIG. 3 shows a cross-sectional view of a multi-core submarine power cable 1′. The submarine power cable 1′ comprises three power cores 15, 17 and 19. The first power core 15 is formed at least partly by the first conductor 3, the first insulation system 5, and the optional water barrier 7, which in this case is a first water barrier, described above. The second power core 17 and the third power core 19 may be identical to the first power core 15. Thus, the second power core 17 comprises a second conductor 21, a second insulation system 23 provided around the second conductor and optionally a second water barrier 25 arranged around the second insulation system 23. The third power core 19 comprises a third conductor 27, a third insulation system 29 provided around the third conductor 27 and optionally a third water barrier 31 arranged around the third insulation system 29.

The first power core 15, the second power core 17 and the third power core 19 form a stranded multi-core. The three power cores 15-19 are hence stranded.

The submarine power cable 1′ comprises an armour layer that surrounds the stranded multi-core. The armour layer forms a common armour layer for all three stranded power cores 15-19. The armour layer comprises the previously described armour elements 9. The armour elements 9 are arranged helically around the stranded multi-core.

The submarine power cable 1′ comprises an outer layer 13 surrounding the armour layer.

In other variations of the submarine power cable, the submarine power cable may comprise exactly two power cores or more than three power cores.

The inventive concept has mainly been described above with reference to a few examples. However, as is readily appreciated by a person skilled in the art, other embodiments than the ones disclosed above are equally possible within the scope of the inventive concept, as defined by the appended claims.

1. An AC submarine power cable comprising:
a first conductor,
a first insulation system provided around the first conductor, and
a plurality of elongated armour elements forming an armour layer surrounding the first insulation system,
wherein each elongated armour element is made of a plurality of individual wires that are stranded,
wherein at least some of the individual wires comprise metal, and
wherein each individual wire of the elongated armour elements is covered with bitumen.

2. The AC submarine power cable as claimed in claim 1, wherein the metal is mild steel.

3. The AC submarine power cable as claimed in claim 1, wherein the metal is stainless steel.

4. The AC submarine power cable as claimed in claim 1, wherein each elongated armour element is a wire rope.

5. The AC submarine power cable as claimed in claim 1, wherein a diameter of each elongated armour element is in the range of 4-8 mm, such as 5-6 mm.

6. The AC submarine power cable as claimed in claim 1, wherein for at least one of the elongated armour elements all individual wires have the same diameter.

7. The AC submarine power cable as claimed in claim 1, wherein at least one of the elongated armour elements includes a central individual wire and six individual wires wound around the central individual wire.

8. The AC submarine power cable as claimed in claim 1, wherein the elongated armour elements are arranged helically along an axial direction of the submarine power cable.

9. The AC submarine power cable as claimed in claim 1, comprising a first water barrier arranged between the first insulation layer and the armour layer.

10. The AC submarine power cable as claimed in claim 9, wherein the first water barrier comprises a metallic sheath.

11. The AC submarine power cable as claimed in claim 9, wherein the first water barrier comprises a polymer sheath.

12. The AC submarine power cable as claimed in claim 1, wherein the first conductor and the first insulation system form part of a first power core wherein the submarine power cable comprises:
a second power core including:
a second conductor, and
a second insulation system provided around the second conductor; and
a third power core including:
a third conductor, and
a third insulation system provided around the third conductor;
wherein the first power core, the second power core and the third power core form a stranded multi-core, and wherein the armour layer surrounds the stranded multi-core.

13. The AC submarine power cable as claimed in claim 1, comprising a corrosion protection layer provided on the elongated armour elements.

14. The AC submarine power cable as claimed in claim 13, wherein the corrosion protection layer comprises bitumen.

15. The AC submarine power cable as claimed in claim 14, wherein each elongated armour element is covered with the bitumen around its entire circumference.

16. (canceled)

17. The AC submarine power cable as claimed in claim 1, wherein each individual wire is in direct contact with bitumen around its entire perimeter surface.
